(19) United States
(12) Patent Application Publication
(10) Pub. No.: US 2005/0080734 A1
(43) Pub. Date: Apr. 14, 2005

(54) Method, system, and computer program product for trading diversified credit risk derivatives

(75) Inventors: Fergus Lynch, London (GB); Alexander Duering, London (GB)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Deutsche Bank AG, London (GB)

(21) Appl. No.: 10/913,145

(22) Filed: Aug. 6, 2004

(30) Foreign Application Priority Data
Aug. 6, 2003 (GB) 0318441.3

(51) Int. Cl. G06F 17/60

(52) U.S. Cl. 705/40

(57) ABSTRACT

A method and apparatus for trading a standardised contract. The contract obliges the seller to make delivery to the exchange of a standardised debt product on the delivery date of the contract for a price given by the exchange determined settlement price and a conversion factor. The contract further requires to take delivery from the exchange of said debt obligation for the same price. The contract further requires the buyer or seller to make margin payments to the exchange on each trading day, or with a longer period, based on the price movements of the contract during that trading day or period if so required by the trading rules. The contract further obliges the exchange to make similar payments to the buyer or seller if they are entitled to such payments under the trading rules.

### RELATED APPLICATIONS

Foreign priority benefits are claimed under 35 U.S.C. § 119(a) of United Kingdom application 0318441.3, filed Aug. 6, 2003 and titled “Method, System, and Computer Program Product for Trading Diversified Credit Risk Derivatives.”

### BACKGROUND TO THE INVENTION

1. Field of the Invention

The invention relates to a product, and the method of trading and settling of this product, which is related to price movements of defaultable debt instruments, respectively, to derivatives linked to such defaultable debt instruments, such as, for example, a contract, method, system and computer program product for trading diversified credit risk exposure. Such a contract requires the seller to deliver, and the buyer to take delivery of, a standardised privately issued security that has a defined exposure to price changes of defaultable debt obligations. The price of the security to be received by the contract seller, and to be paid by the contract buyer, depends on the last trading price of the contract and may also depend on a conversion factor incorporating the characteristic features of the deliverable security.

2. Discussion of the Background

Corporate bonds form part of the financing sources for modern companies, together with equity, bank loans, and structured financing products. Companies make use of these financing alternatives according to their preference for the various trade-offs between costs, risks, and flexibility afforded by each of these products. Some of the considerations made by such companies are well described in the corporate finance literature, such as the book ‘Principles of Corporate Finance’ by Brealy and Myers which is available in regular new editions from McGraw-Hill companies and which is here incorporated by reference.

While corporate financing in Europe has traditionally been dominated by equity participations and bank loans, the corporate bond markets in the United Kingdom and the United States have long been very large compared to the market for bank loans. Recently, the introduction of the common currency (euro) in several countries in Europe has improved the liquidity of the European financial markets and correspondingly increased the attractiveness of corporate bonds to issuers and investors alike. The total size of the corporate bond markets globally is difficult to establish given the lack of universal reporting requirements, but known to exceed three trillion dollars.

Because lenders to corporate or sovereign borrowers at times need to reduce their credit exposure to their borrowers but may be legally, contractually or morally unable to do so by selling on the respective debt instrument, a liquid market in credit derivatives has developed over the recent years. The most common credit derivative used in the market is a so-called credit default swap (CDS). CDS have been very well standardised, most recently by the 2003 ISDA standard definitions for credit default swaps, which is incorporated here by reference.

A credit default swap is a contract between two parties, commonly referred to as the protection seller and the protection buyer. In this contract, the buyer agrees to pay the seller a set fee, usually quarterly for a total period of five years or until a credit event occurs. In exchange, the seller agrees to purchase in the case of default of a given reference entity debt obligations of this reference entity for a price of par. The precise nature of the default event triggering the purchase obligation of the seller depends on the individual CDS contract, but is usually linked to such events as failure to pay, repudiation, moratorium restructuring, etc. of the borrower with respect to a given set of reference obligations. Similarly, the CDS contract governs such issues as the set of debt obligations that are deliverable by the buyer to the seller, and the modalities of cash settlement should there be no deliverable obligations. The role of the ISDA definitions is to provide for common definitions of all the relevant events so as to reduce the complexity of individual CDS contracts and to make CDS contracts as fungible as possible.

Institutional investors in fixed income instruments are usually, like investors in the equity markets, guided in their decisions by benchmarks laid down by the suppliers of their invested funds, or the trustees of these investors. The benchmarks used in the fixed income markets are usually very broadly diversified portfolios of bonds chosen by size and their attendant features, such as coupon type, redemption options, and the like. Examples of well-known fixed income benchmarks include the Lehmann Aggregate Bond Index family and the iBoxx index family.

Users of the international markets for corporate debt are faced with a liquidity problem when attempting to manage and hedge large portfolios. Investors generally have views on the credit market as a whole, for instance, that a decline in economic activity will bring about an underperformance of corporate debt versus government debt. Because many investors are highly skilled at analysing the market in such general terms, it would be highly advantageous for the efficiency of the financial markets if they were able to express these views through reallocations of the portfolios entrusted to them by their investors. However, they are currently unable to trade on such general views because there is no liquid generic credit instrument available in the market. Instead, nearly every trade in the credit markets has to be executed using a name-specific instrument, such as a particular corporate bond or a credit default swap (CDS). Using either of these instruments requires a name-specific credit analysis to be conducted on the issuer in question. This is onerous for smaller investors without large research budgets or access to high-quality third-party research. Furthermore, many investors are prevented from using CDS due to the over-the-counter (OTC) nature of the instrument, which may clash with investment mandates that require an exchange listing for all traded securities. Such investors are confined to trading bonds, which introduces further complications that distract from the original view on credit due to such effects as specialness in the bond lending (repo) market, supply shortages, tax-driven coupon effects, and the like. In short, investors do have valuable skills that could benefit the public at large, but are currently hindered from applying these skills fully in the management of their portfolios due to the absence of an effective trading instrument that provides a generic exposure to the credit market.

A similar problem arises when institutional investors are given mandates to manage large amounts of funds against a corporate benchmark. It is in the interest of those providing the finds to see them invested as soon as possible in order to earn the income provided by the market. However, attempting to purchase large diversified portfolios in a short amount of time will alert dealers to the existence of a large buying interest and induce them to react to this information by raising prices of corporate debt. This will lead to a friction loss for the investors of the funds that is known as ‘information loss’. Minimising this information loss whilst providing speedy investment of funds is one of the main challenges of institutional fund management. Naturally, the reverse effect is present when funds are withdrawn from fund management leading to further information loss on exit.

Attempts to provide an instrument that can address these difficulties have been made by a number of investment houses. The instruments produced by these houses generally consist of securities that are linked to the performance of a portfolio of credit instruments, or a subset thereof. These securities are created by placing corporate bonds, credit derivatives, and collateral, or combinations thereof, in a trust that is legally separate from the sponsoring institutions, and selling participations in the trust's income to investors. The portfolios held by the trust are structured by the sponsoring institution such as to find a large buying interest. This is usually done by achieving, or claiming to achieve, a close relationship between the anticipated performance of the portfolio and the anticipated performance of a broad credit index. Achieving a close relationship between an actual bond portfolio and a broad credit index is costly, and the instruments available in the market accordingly strike different balances between the quality of the index reproduction and the costs charged to the investor. While structurally the resulting instruments are rather illiquid, the sponsoring institutions do generally commit to make markets for at least some time after issuance in order to allow investors to exit the position. However, investors are usually forced to rely on a particular market maker for secondary market liquidity. This creates an additional basis risk relative to their chosen credit benchmark because the valuation of the instrument they are holding does not depend only on its intrinsic value (i.e., the sum of the values of its constituents), but also on the willingness of one market participant (i.e., the originator) to deal at or near this intrinsic value. Investors in these products are also forced to gain approval for investing in notes of the legal issuer of these bonds because that issuer will normally be the trust. This extra step of seeking credit approval makes investments in these notes more onerous and may prevent investment altogether for those investors with strict credit guidelines.

Because exchange-traded futures contracts offer a transparent market with potentially very high liquidity, futures exchanges have in the past attempted to launch futures contracts based on the performance of defaultable bonds.

Futures contracts, i.e., contracts that call for the delivery of goods of certain standardised quality and quantity at a future point in time have been in use for several centuries. The first futures contracts were linked to agricultural goods, such as rice or pork, but at this point, futures on financial instruments show the highest trading volumes. The futures on bonds are most relevant for the inventive contract as these contracts also refer to long-term loan obligations. For bond futures, several problems apply that are addressed with the inventive contract. The first is the so-called quality option which refers to the right of the seller or a bond futures contract to choose the instrument that is delivered to the buyer of the contract. In an agricultural futures contract setting, this option refers to the choice which particular variety of rice or hogs to deliver, and generally corresponds to the fungibility of the respective products in the eyes of most consumers. In modern bond markets with narrow bid-offer spreads, providing a basket of bonds from which the seller can choose a particular bond for delivery does usually not address a similar economic need. Usually, there is exactly one bond that is economically most attractive to deliver for the seller (the so-called cheapest to deliver, or CTD, issue) and delivery is concentrated on this single issue. In economic terms, delivery of any but the cheapest to deliver issue is so onerous for the seller of the contract as to make the hedge purpose of the contract sale irrelevant. The existence of other deliverable bonds, however, leads to complications in valuing the contract as the option that arises from possible changes in the ex-ante cheapest to deliver is complicated to evaluate. The inventive contract addresses this issue by specifying precisely one deliverable issue.

The existence of a clear CTD can also lead to situations where speculators create an artificial shortage in the CTD bond in order to realise excessive profits from taking delivery of more expensive to deliver issues. It is one of the purposes of the inventive contract to address this problem by using a deliverable bond that can at any time be increased in size through a transparent mechanism. It would therefore be impractical for speculators to try and amass large holdings of the CTD issue in the hope to restrict delivery opportunities.

There are two principal designs of futures contracts with some relationship to credit spreads currently in use. The first type of contracts requires delivery of debt obligations with certain characteristics from a predetermined set of issuers while the second type is cash-settled against a benchmark interest rate, or set of benchmark interest rates that is thought to correlate well with interest rates of corporate bonds.

Contracts on individual credit bonds usually confine the deliverable set of bonds to issues of very high quality borrowers that issue large and liquid bonds. This restrictions is necessary because any futures contract on an instrument for which there is no universally agreed-upon fixing process needs to be designed such that, in theory at least, a large part of the total open interest can actually go through to delivery without disrupting the underlying market. It is also necessary that there are low transaction costs involved in trading the basis, i.e., the spread, between deliverable bonds and futures contract in order to ensure a fair valuation of the futures contract relative to the underlying cash instruments. Because short selling of the basis is only possible if there is sufficient liquidity in the repurchase (repo) market, a well-functioning repo market is also essential. The absence of both features (large, liquid bond issues and a deep repo market) in the corporate bond universe appears to have prevented the success of such credit futures.

The only products that proved to be at least marginally successful are those linked to benchmark rates in the form of interest rate swaps. These contracts are settled through cash payments based on the valuation of predetermined notional interest rate swaps using generally respected pricing sources. While interest rate swap rates are generally seen as reflecting the general movements of credit spreads, they do not in reality contain a credit exposure that would be comparable to that of a bond. Furthermore, there have been instances of large movements in credit spreads that were not accompanied by similar movements in swap spreads, and vice versa. In particular, the high concentration of swaps trading among a small number of investment banks means that perceived problems at one of these banks can lead to large short-term movements in swap spreads that are not related to changes in the credit markets as a whole. This leads to occasionally volatile swap spreads of corporate bonds, and hence to poor performance of strategies that rely on interest swaps to replicate corporate bond portfolios. In other words, although futures contracts based on interest rate swaps have gained some modicum of acceptance, they do not address the wider issue of hedging credit exposure.

So far, every major existing futures contract calls for the delivery of a fixed-rate bond. For a corporate bond, there are two components that influence the pricing of this bond: general movements in interest rates for risk-free lending and movements in the premium charged by the market for lending to the particular issuer of the bond under consideration. It is one of the aims of the contract to make the contract pricing independent on risk-free interest rates and thereby make price movements of the contract dependent on credit spread movements only.

### SUMMARY OF THE INVENTION

Preferred embodiments of the present invention are based on the combination of a standardised credit product that can serve as the underlying basis for an inventive futures contract with exchange-traded futures technology.

Preferred embodiments of the invention provide a novel method of trading and settling futures contracts so that a privately issued bond can serve as underlying without compromising liquidity.

Preferably embodiments of the invention provide a method of trading and valuing futures contracts based on floating-rate notes.

Preferably embodiments of the invention provide a method of trading and hedging exposures to diversified credit portfolios.

Preferably embodiments of the invention provide increased liquidity in a corporate credit market by the creation of a liquid hedge instrument.

Preferably embodiments of the invention provide wider access to the credit markets through the introduction of a liquid, standardised, exchange-traded instrument linked to the performance of the overall credit market.

Preferably embodiments of the invention offer investors with fixed coupon benchmarks an instrument to trade both credit spread and fixed rate exposure through the combination of two futures contracts.

In preferred embodiments of the invention there are provided a method, system, and computer program that addresses the shortcomings of cash trading by establishing a new futures contract. Because futures contracts can be traded in volumes that far exceed the amount of spot product that is normally traded, investors have a product that has a liquidity in excess of the underlying cash market. At the same time, by defining a synthetic underlying that can be created and destroyed at short notice, the problems that would otherwise exist with futures contracts on corporate bonds, in particular the liquidity in the cash market and the difficulty in bond borrowing (repo trading) are eliminated. The futures contract is physically settled to prevent dependency on a widely respected pricing source which currently does not exist in the credit market.

An exchange rule that prevents parties that control supply to take physical delivery in the contract addresses concerns about a potential conflict of interest between issuers of the underlying security and users of the futures contract.

One advantage of embodiments of the present invention is to combine the virtues of exchange-traded futures contracts with the technology of credit derivatives to create an instrument that can provide a liquidity for investors in the credit market that can far exceed that of any single cash credit bond.

### BRIEF DESCRIPTION OF THE DRAWINGS

A preferred embodiment of the invention will now be described in detail by way of example with reference to the accompanying drawings in which:

FIG. 1 shows the general structure of a trading environment for the new contract in an embodiment of the invention;

FIG. 2 schematically describes the structure of the credit-linked note underlying the contract in an embodiment of the invention;

FIG. 3 demonstrates the development through time of the notional amount of the underlying note as defaults affect the collateral place with the note's issuer;

FIG. 4 provides a sample timeline for the trading of a contract embodying the invention; and,

FIG. 5 demonstrates the data flow between the objects constituting the electronic exchange trading system.

### DESCRIPTION OF THE PREFERRED EMBODIMENTS

A contract embodying the invention is traded on an exchange which may or may not be an existing futures exchange. Examples of existing futures exchanges are Eurex, the London International Financial Futures Exchange (LIFFE), and the Chicago Board of Trade (CBOT).

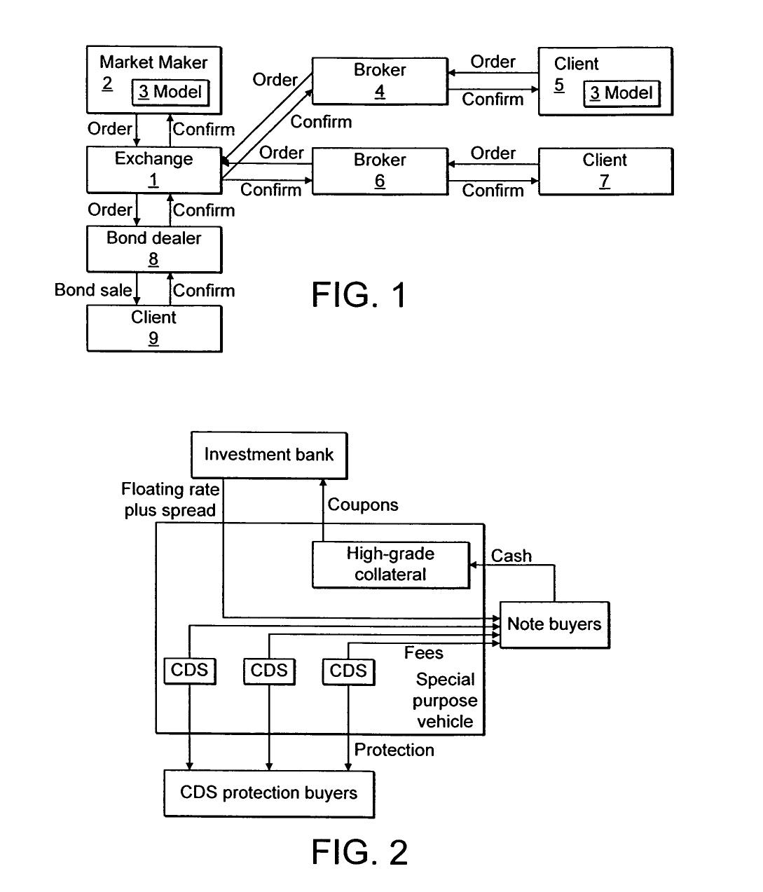

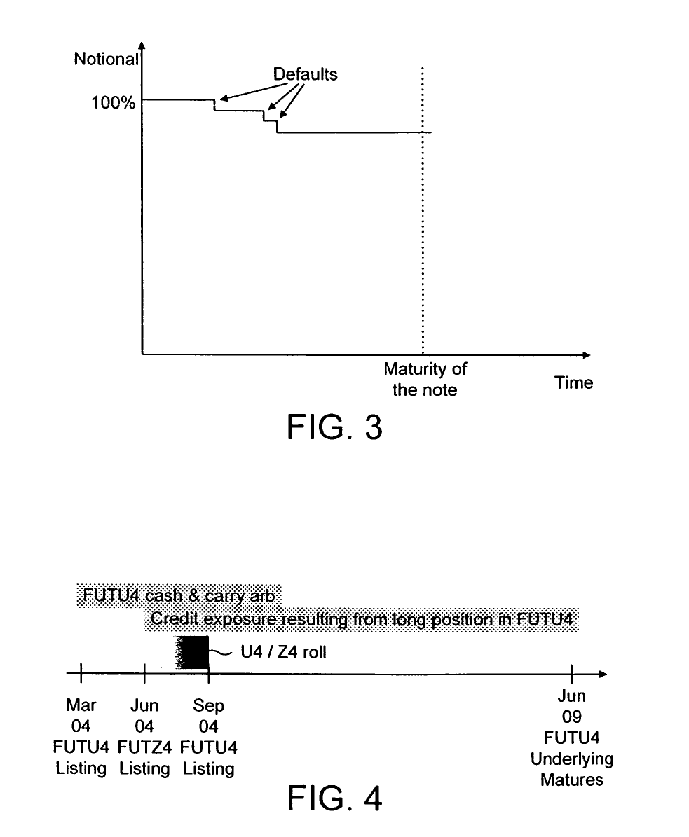

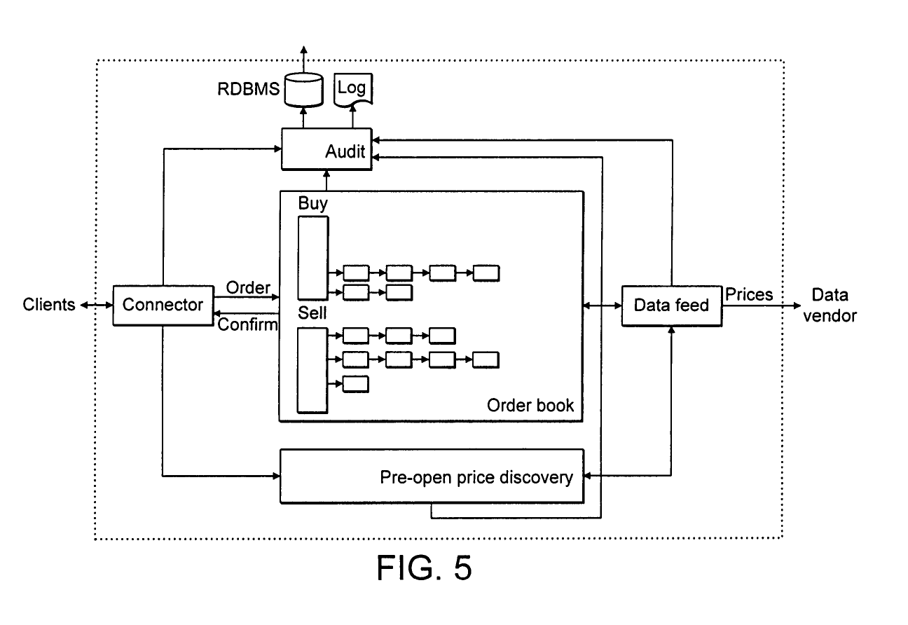

FIG. 1 demonstrates trading in the contract listed on the exchange 1. There may or may not be designated market makers 2 who provide continuous prices, which may or may not be based on a pricing model 3. In the initial phase of launching a new futures contract, such market making is desirable because it increases liquidity in the new contract. As trading volumes increase, market making is usually no longer necessary. Trading occurs by the market participants 2, 4, 6, or 8 placing orders with the exchange and the exchange confirming the execution of the orders to the originators of the order. In line with other existing contracts, orders may be specified as at-market orders for immediate execution at the current market price, or limit orders for execution at a predetermined price. Limit orders may further specify additional restrictions, such as automatic expiry at the end of the trading day, or fill-or-kill execution requiring automatic expiry of the order if it can not be filled immediately. The exchange trading rules may or may not prevent some participants, in particular market makers, from supplying certain types of orders, such as limit orders.

It is the task of the exchange to ensure that orders are executed as pairs of buy and sell orders even though the exchange appears as the legal counterparty, or agent of such a counterparty, of each side of the order. A central counterparty reduces the capital charge incurred through trading in the contract as the obligations under the contract may partially be offset against entitlements arising from other contracts traded on the exchange by the same exchange member. A central counterparty also reduces the default risk faced by each user of the contract if the central counterparty is well capitalised.

In order to provide orderly trading on the exchange, the exchange will usually restrict its counterparties to a set of brokers or banks that satisfy certain high standards. These brokers 4 and 6 can act as agents for contract users that are not members of the exchange 5 and 7. Typically, these brokers will manage the payment obligations under the contract privately with their clients. The clients may themselves be using the contract to speculate on the relative performance of the contract against some pricing model (client 5) or use the contract outright to establish or reduce exposure to the credit markets (client 7).

Trading houses making markets in corporate bonds 8 may also be using the contract. Faced with a client order regarding a bond trade by a client 9 that has no relationship with the contract, the broker 8 may nevertheless use the contract to reduce the risks arising from assuming the trading position resulting from providing the market making service to client 9.

For reasons of efficiency, the exchange may choose to allow trading in the contract using an electronic network service, such as the Internet or proprietary computer networks. Compared to trading based on other media, such as open outcry on the exchange floor or voice communication, electronic trading may be faster and more secure. Existing exchanges typically already have electronic trading systems at their disposal which may be adapted for the purpose of trading the contract.

The contract requires physical delivery of a predetermined notional of a note that has been issued according to a set of predetermined rules by a predetermined issuer. The issuer is a special purpose vehicle (SPV) set up by one or plural investment banks with the single business purpose of issuing notes that conform to this, or a similar, set of rules. The status of the SPV as an independent legal entity is enhanced by an independent board of directors. This legal independence of the SPV from the sponsoring banks makes the credit quality of the SPV independent from those banks and removes the need to consolidate the SPVs accounts within the accounts of these banks. The notes are fully funded (backed by collateral) and the paid funds are invested in collateral with negligible credit risk. These can be bonds such as covered bonds issued under the applicable legislation conforming to article 22(4) of the directive 85/611/EC on “The coordination of laws, regulations and administrative provisions relating to undertakings for collective investment in transferable securities (UCITS)”, or equivalently secured debt issues in other jurisdictions, such as US government-sponsored entity debt. In order to remove interest rate risk from the SPV, the collateral is asset-swapped with one or more investment banks such as to obtain quarterly floating rate cash flows. In effect, the asset swapped collateral can in economic terms be viewed as a single security paying floating rate cash flows, which form the basis of the coupon payments the SPV makes to holders of the note. The SPV further enhances the coupon by selling default protection in the form of CDS on a large basket of high-grade names, thereby earning the protection fee paid on the CDS until defaults occur. FIG. 2 below shows an outline of the structure of the issuing SPV.

The notes initially pay a floating rate coupon equal to the weighted average CDS spread on the full notional on top of an appropriate benchmark rate, such as the 3 months London Interbank Offered Rate (Libor) or the Euro Interbank Offered Rate (Euribor) as appropriate for the payment currency. As defaults occur, parts of the collateral held by the SPV are sold to fulfil the SPV's obligations under the corresponding CDS. Funds obtained from the sale of the collateral that are not needed to satisfy the CDS obligation are paid out pro-rata to note holders. Each default will therefore reduce the outstanding notional of the notes pro-rata, and lead to a change in the spread paid as the new spread is the weighted average of those CDS that have not been triggered yet. The possible development through time of the note notional is shown in the example below.

The transparent structure of the notes ties the intrinsic value of the notes closely to the CDS market, which in turn is tied closely to the corporate bond market due to the high liquidity in CDS spread basis trading. In particular, the market value of the notes will change as and when the quoted spreads on the CDS written by the SPV against the note change. The note will be issued by the SPV in concert with a consortium of banks who will also act as market-makers in the cash market. The outstanding amount of the notes can be increased on demand. Increasing the outstanding amount of the notes is relatively simple because the CDS market provides sufficient liquidity.

The issuing consortium has no influence on the composition of the CDS portfolio written by the note which is instead constructed according to set of public rules that is independent of the issuing syndicate. For instance, the portfolio can consist of 100 names selected by their contribution to a broad credit index, but with equal weighting. Moving to equally weighted CDS makes the note basket more stable in the run-up to the note issuance than would be the case with market value weighting as new supply will most likely leave the basket unchanged unless it changes the ranking of names in the index.

The notes into which the contract expires may be issued according to a schedule that is aligned with the expiry schedule of the future which should be comparable to the quarterly expiry schedule of usual bond contracts. The notes should therefore also be issued according to a quarterly schedule. In order to provide for a high transparency in the market of the notes, the notes should be issued before the most active trading phase of each contract expiry. Because the CDS market trades generally on forward first coupon days that are the 20th (or following good business day) of March, June, September and October, the (single) expiry day of the contract should coincide with the first payment date of the CDS contracts, i.e., the 20th of the delivery month or following exchange day. It would therefore be desirable to issue the notes with an initial time to maturity of eg 5.25 years and to have the contract expire into the notes that have reached a remaining time to maturity of eg 4.75 years, providing for a six month trading window for the contract.

In order to provide time for the issuing syndicate to create extra supply should the demand for physical delivery of the contract be larger than expected, the contract should have a slightly longer settlement period than currently existing futures contracts. In particular, the contract could call for physical delivery on the last good business day of the delivery month or some other period. This would provide about one week for the issuing syndicate to increase the size of the notes should this be called for.

The fact that the note issuance is controlled by the market-makers creates a potential conflict of interest between them and the other users of the futures contract. A market-maker may attempt to build a large long position in the future and then refuse to provide an adequate supply of notes during the delivery phase in order to benefit from the resulting fall in the basis. The contract should therefore be accompanied by an exchange rule that prohibits market-makers in the note from taking physical delivery. This rule does not affect the economics of bona-fide trading in the contract because market makers can always close out long positions through an offsetting short position.

Because the note has a floating rate coupon, its pricing contains next no interest rate risk component. It does, however, contain a spread risk component that is comparable to a fixed rate bond of the same maturity. Because the contract is best implemented as a contract on a single underlying so as to make the analysis simpler, there is no reason to use anything but the price of the underlying notes as the daily settlement price of the contract. As the liquidity of the contract improves, however, it may be attractive to list the contract long before the notes start trading. This means that the cash price of the notes will be unavailable at the beginning of trading, and that the spread over the benchmark interest rate paid by the notes will also be unknown. While the composition of the notes' CDS basket can be estimated with some certainty, the final spread will be set according to the market for CDS on the underlying names at the time of the first selling the notes. It is then necessary to settle the future using a conversion factor that adjusts for the difference in fair value for notes paying different spreads for the same basket of underlying CDS. In other words, before the note is issued, changes in the conversion factor will drive changes in the future's price while the expected price of the underlying will be par. Once the note is issued, the conversion factor remains constant and the future's price changes are driven by price changes of the note itself. The calculation of this conversion factor should be defined such as to make the contract pricing and risk management as simple as possible for all market participants.

A useful way to calculate the invoice price of the future is therefore to use a formula that bears some resemblance to the invoice price calculation of existing fixed rate bond futures. We therefore see conversion factors calculated according to the following formula as useful:

$$C ( x ) = ( {\sum }_{i = 1}^{19} \frac{( 6 + x ) / 4}{{( 1 + 7 \% / 4 )}^{i}} + \frac{100}{{( 1 + 7 \% / 4 )}^{19}} ) / 100$$

This example is for a Note paying a spread of x percent quarterly (e.g., 0.67 for a note paying Euribor+67 bp) delivered 19 quarters before maturity (1 quarter after issuance). This formula will yield a conversion factor of exactly 1 for a note paying 100 bp over Euribor. The formula itself is chosen for its similarity with the conversion factor calculation for other bond contracts. If Euribor were to be a flat 6% rate, the conversion factor would correspond to the price of a bond with quarterly coupons yielding exactly 7%. Note that we have not used daycount adjustments for simplicity. In the absence of those daycount adjustments, the formula can be evaluated to approximately
C(x)=(4.01151x+95.98846)/100

The conversion factor calculation implies a spread duration of around 4.01, which is roughly in line with typical spread durations of most broad credit indices. This means that the notional of a futures position that hedges a given credit portfolio will be roughly the same as that of the credit portfolio itself. This should make the use of this contract transparent even to less sophisticated users.

The exchange needs to prevent the build-up of large mark-to-market exposures in order to ensure the performance of the contract users vis-à-vis each other and the exchange. In other words, while each position in the contract is initiated at fair value by definition, a move in the contract price will engender a payment obligation either on part of the buyer (if the contract price declines) or the seller (if the contract price increases). In order to limit the size of the outstanding payment obligation, the exchange may use initial and variation margin payments. Initial margin payments become due when a new futures position is initiated and should be chosen in size such that the exchange is protected against the largest movements in the contract price that are likely to occur before a failure to perform of a contract user can be noticed. A variation margin is the payment of funds due as a result of the movements in the contract price. For instance, if the contract price increases, the holders of long positions (net buyers) of the contract have achieved an economic gain while the holders of short positions (net sellers) face an economic loss. The process of variation margining there consists of collection the corresponding funds from the shorts and transferring it to the longs. Because for the exchange the process of collection variation margin is the most reliable method of assessing ability to pay for each trading participant, variation margining should be conducted as frequently as reasonably possible, i.e., daily, and the initial margin per contract should therefore be equal to the likely largest daily movement in the contract value.

If the exchange listing the contract also lists a contract based on a default-free or virtually default-free fixed-coupon underlying bond with a maturity of around 5 years, this exchange could also offer the option of trading the sum of one contract with one fixed coupon contract. Because the inventive contract is based on a floating rate note, it will be almost insensitive to changes in longer-term interest rates. At the same time, it will have a spread exposure that is similar to a broad credit index. In contrast, the contract on the default-free or virtually default-free 5 Y bond will not have a credit exposure, but it will have a 5 Y default-free interest rate exposure. The combination of the two contracts therefore has both the 5 Y interest rate exposure and the 5 Y spread exposure, which brings it in line with a fixed-rate credit index. Because only the combination of both contracts provides this exposure, offering the companion trading facility increases liquidity in both contracts at the same time instead of leading to cannibalisation as would be the case if the credit-based inventive contract were based on a fixed coupon bond.

Description of the Computer Program Implementing the Contract Trading

The computer program described here can be implemented on a general purpose computer such as a standard PC similar to a Compaq Evo W 6000, the technical description of which is available from the manufacturer (Hewlett-Packard) and incorporated herein by reference. The computer is assumed to run a modern operating system supporting multi-threaded tasks, such as Linux or Windows XP. The program can also run on larger mainframe machine as dictated by the trading volumes experienced by the contract. In either case, the computer is assumed to be connected to a computer network such as a local area network (LAN) or wide area network (WAN) which allows electronic order entry by the trading counterparties of the exchange. It is assumed that the network is protected from malicious users either on the physical layer (OSI reference model layer 1) through isolation of the network from other networks, or at the transport layer (OSI reference model layer 4) through virtual private network (VPN) software. It is also possible to secure the data at the application layer (OSI reference layer 7), but the necessary modifications of the computer program would distract from the presentation of the computer program.

The computer program implementing trading in the contract is realised as a multi-threaded application in a programming language supporting the development of such applications such as Java or C++. A multi-threaded application is one where a single program image and data structures exist, but program execution may occur simultaneously (in the presence of plural central processing units) or quasi-simultaneously at different points in the program image. In order to reduce the complexity of the application, it is implemented as a set of objects with well-defined interfaces through which data interchange between the objects occurs. There are five main objects interacting in the computer program, with the general outline shown in the chart below. The first and central object implements the order book. The order book consists of two arrays holding entries of a structured data type that describes the set of limit orders with a given limit price. The two arrays hold buy and sell orders, respectively, and are ordered by order price. The data structures held in each array are essentially similar and consist of a counter holding the number of orders at this point, a floating point number holding the limit price that is common between these orders, and a reference or pointer to the first in a linked list of actual order entries. Each order entry is a structured data type holding the originator of the order, the time of order entry, and markers further describing the permitted executions of the order. The orders for the same limit price are held in a singly-linked list ordered by time of order entry. The order book object has a method for instantiating a new order book object (constructor) and two order entry methods. The first order entry method accepts so-called market orders and leads to immediate execution. Immediate execution is effected by selecting the best price (highest bid price from the limit buy order queue for a sell order or lowest ask price from the limit sell order queue for a buy order) and attempting to execute the market order by matching it against the corresponding orders from the appropriate queue of limit orders. Limit orders are consumed from the head of the limit order queue until the market order is completely filled or there are no more limit orders left. Limit orders are not removed from the queue (and skipped by the process attempting to match market orders) if filling the market order would require splitting the limit order into a matched and an unmatched part and the limit order is marked as not allowing partial fill. The second order entry method places new limit orders in the appropriate queue. New limit orders are entered by populating the appropriate place in the array of limit prices with a new object describing orders at this price, as described above unless such an object has already been created. Once the object exists, the number of orders outstanding at this point is increased by the appropriate number of contracts as described in the new order, and the order is appended to the end of the linked list of outstanding limit orders at this price. Placing a new order also triggers execution of a new thread that attempts to match outstanding limit orders. For instance, if a new limit order is entered to sell 1200 contracts at a price of 102.24 and there is an existing limit order to buy 980 contracts at a price of 102.24 that has not yet been matched, the order matching process can execute the pre-existing buy order and replace the newly entered sell order with a new limit order to sell 220 contracts at a price of 102.24 if the new order allows partial fill. If partial fill is not allowed for said new sell order, the order matching thread will be unable to process said order until a new buy order with a limit of 102.24 or higher and a size of 220 or larger enters the buy order queue, or a market order with a size of at least 220 contracts is entered. The order queue object is responsible for guaranteeing atomic access to the queue structures through such techniques as semaphores or spin locks. The necessary operations are provided by modern CPUs and supported by modern operating systems and software environments. The order book object further has a clean-up method that removes all outstanding unfilled orders from the order book and, if the orders expire, notifies the customer that their order has not been filled. It is envisaged that this order book method is called at the end of the trading day.

The second important object class implements the connection of the order book to the order entry systems. This connection is maintained by listening to incoming connection requests on specified ports on the host computer and negotiating secured connections with the client software used by the exchange customer. Incoming order messages are then checked and forwarded to the order book object by calling the appropriate order entry method of the order book object. If the order entry method returns the appropriate values, the order is signalled as entered back to the customer client. The connection object also provides call-back methods for the order matching thread of the order book object so as to enable the order book object to notify customers of the execution of their limit orders. The connection object further provides a method to the order book object that can notify a client about orders that have expired without having been filled. The connection objects maintain queues for each customer client that allow for the persistent storage of messages that could not be transmitted due to network failures. Such messages are re-transmitted as soon as a failed connection becomes operational again.

The third important object in the trading application is an auditing object that keeps a record of all transaction of the application, including connections and disconnections of customer clients. To this purpose, the auditing object maintains both one or plural text-style logfiles into which log information is entered, and one or plural connections to one or plural relational database management systems (RDBMS), such as Oracle, Sybase, or MySQL databases. These database systems maintain records of trading tickets, client invoices, settlement amounts, customer accounts, and the like. The auditing object uses messages queues with persistent storage on fast non-volatile memory (such as battery-buffered SRAM disks) to provide for asynchronous access of the auditing object to the database servers in order to provide fast response times of the auditing objects. Such fast response can not be guaranteed by the RDBMS and safe buffering must therefore be provided by the auditing object itself. The auditing object should also check the incoming data to detect violation of trading rules such as the balance between executed buy and sell orders.

The fourth object of the trading application maintains the data transfer to external data providers, such as Reuters or Bloomberg systems. Depending on the level of information purchased by the external data provider, the order book can be transferred in full, or only the best bid and best ask can be shown, possibly accompanied by the total size of the orders at these prices. This data is readily available from the order book object, but because data provision is a less important objective than maintaining an orderly market, the reporting object should be executed in a thread of lesser scheduling priority than the order book or the auditing object. Because reporting will depend on the downstream data provider, the reporting object is likely to be sub-classed further for each provider purchasing exchange data. The further purpose of the reporting object is to calculate an official exchange close, for instance by calculating the volume-weighted average of the last five trades executed during the trading day.

The fifth object implements the pre-trading opening phase and is responsible for collecting bid and ask prices from the client connection objects, processing them, and forwarding the resulting information to the data providers. The purpose of this object is to provide an approximate price guidance to traders using the contract to encourage them to enter limit orders into the exchange at the start of trading.

Customer invoicing, collateral management, and the like are asynchronous functions that can be fulfilled by separate applications on separate machines based on the data provided in the trading RDBMS by the inventive central trading application. If the inventive contract were listed on an existing exchange, these ancillary applications are likely to exist already.

Description of the Computer Program Implementing the Pricing Model

The computer program implementing the contract pricing model in FIG. 1 (3) can be a standard PC similar to a Compaq Evo W 6000, the technical description of which is available from the manufacturer (Hewlett-Packard) and incorporated herein by reference. The computer is assumed to run a modern operating system supporting multi-threaded tasks, such as Linux or Windows XP.

The pricing model needs to first obtain a list of the creditor names contained in the CDS basket of the deliverable note. If the note exists, this list can be obtained from the prospectus, otherwise it can be calculated according to the rules observed in the note construction by the issuing syndicate. This calculation is simple and may be a service offered by the provider of the index that is used in defining the note construction rules. If there is uncertainty about a small number of names in the basket, a pricing model may choose to price several possible notes in parallel.

Once the basket is known, the pricing model needs to obtain the quoted CDS bid levels from the market. Because different market markers may have different preferences as to the side (buying or selling) they would like to deal on in any given name (such preferential trading directions are referred to as axes), the model needs to obtain and combine quotes from more than one dealer to obtain a representative level for the wider market. A possible aggregation method is simple averaging, or, conservatively, to use the lowest bid price. Once aggregate quotes have been obtained, the weighted arithmetic average, weighted by the share of the corresponding name in the CDS basket, can be calculated and provides the protection selling income available to the note. In the case of the equal weighted CDS basket, the weighted average will be equal to the simple arithmetic average. In the next step, a dealer poll needs to be conducted to obtain ask prices in asset swap terms for high grade collateral that can be used for the note collateral pool. Such ask prices are available in direct form from broker-dealers or can be calculated from ask prices of representative bonds and bid swap curves. The sum of the asset swap level and the weighted average CDS price level provides the spread Sₜ a new note would pay if it were issued on the current trading day subject to the appropriate settlement conventions. If the deliverable note already exists, it can be valued according to the formula
P=(Sₒ−Sₜ)*D+100
where Sₒ is the spread actually paid by the existing note, and D is the duration of a par swap with quarterly fixed payments and the same maturity as the note. This duration can be calculated from standard formulas and may require bootstrapping of the swap curve. The procedures necessary are explained in Hull ‘Futures and Options’, which is incorporated herein by reference. If the note does not exist, it will can be assumed to be issued at the scheduled issue date with a spread of Sₜ (possibly adjusted for curve effects, i.e., the CDS quotes need to be adjusted for the forward starting date) and a price of par. In both cases, the note forward price to the delivery date can be calculated according to standard forward price calculations which are explained for instance in Anthony Wong ‘Fixed Income Arbitrage’ which is incorporated herein by reference. Starting point is a date with a known price and coupon spread (the current trading date for an existing note, or the scheduled issue date for an anticipated note) and the end point is the delivery point (last good trading day of the delivery month). Once this forward price is obtained, it needs to be divided by the conversion factor to obtain the futures price which would correspond to the calculated forward price of the note. This is the fair value of the futures contract.

The calculations outlined above can be conducted by means of a spreadsheet using standard software such as Excel or Open Office, with dealer quotes for CDS levels and collateral swap levels input manually or through automatic price feeds from standard providers. However, once trading in the contract becomes more active, dealers implementing pricing models will probably choose to do this using standard procedural programming languages in order to automate and improve the robustness of this process.

Alternative Implementations

There are a number of alternatives in terms of underlying note, expiry date, and invoice price calculation.

The notes could be constructed by using CDS baskets that resemble the index more closely than the equally weighted basket proposed here. However, the advantages of lower tracking error have to be weighed against the advantages of the certainty the arrangers of the note issuance have about the basket composition early on if the basket is equally weighted. At the same time, the difference in tracking error between the equally weighted basket and an index-weighted basket is likely to be no more significant than the basis risk faced by contract users who are not exposed to the exact index used in the basket construction. In other words, as there is no single common index shared by all investors as a benchmark, there is no unique weighting scheme that minimised the tracking error for all investors. Additionally, using equal weighting limits the maximum size of any name in the basket (to 1% for 100 names), which makes it less likely that the construction of the Note disrupts the underlying CDS market. The advantages of using an equally weighted basket therefore appear to outweigh the obvious deficiencies.

The expiry date is chosen to provide for the best liquidity in the underlying Note at delivery. Because large open interest going into delivery may require additional supply, it is necessary that the ingredients (CDS) used to produce the Note are available in sufficient volumes not to disrupt the underlying market.

The invoice price calculation was chosen to provide an optical similarity to the invoice price calculation for fixed rate bonds in Europe, Japan, and the US, where generally 6% notional coupons are chosen to correct for coupon and maturity effects in the pricing of the deliverable bonds. The formula proposed here uses a 6% notional coupon plus a 100 bp notional spread. It should be possible to calculate a more precise invoice price using a stripped swap curve. However, the additional precision gained by this procedure does not outweigh the additional difficulty for investors trying to understand and use the product.

1. A tradable futures contract between a buyer and a seller, the contract being tradable through an exchange and comprising a requirement for the seller to deliver and the buyer to receive a deliverable debt obligation with payment linked to performance of a set of debt obligations of a plurality of debt issuers, the delivery and payment being due on at least one of a plurality of days.

2. A tradable futures contract according to claim 1 in which the deliverable debt obligation is a floating rate note.

3. A tradable futures contract according to claim 1 in which the deliverable debt obligation is linked to the performance of the set of debt obligations through a plurality of sold (written) credit default swaps on the issuers of these debt obligations.

4. A tradable futures contract according to claim 1, where the invoice price for a floating rate note is calculated using a discount factor that is calculated as the discounted value of notional cash flows using the actual spread but a notional floating index rate and a fixed discount rate.

5. A method of trading a contract comprising the steps of trading a contract having a requirement for a seller to deliver and a buyer to receive a deliverable debt obligation with payments linked to performance of a set of debt obligations of a plurality of debt issuers, the payments being due on at least one of a plurality of days.

6. A method of trading according to claim 5 in which the deliverable debt obligation is a floating rate note.

7. A method of trading according to claim 5 in which the deliverable debt obligation is linked to the performance of the set of debt obligations through a plurality of sold (written) credit default swaps on the issuers of these debt obligations.

8. A method of trading according to claim 5, where the invoice price for a floating rate note is calculated using a discount factor that is calculated as the discounted value of notional cash flows using the actual spread but a notional floating index rate and a fixed discount rate.

9. A computer implemented method of trading comprising the steps of trading a contract having a requirement for a seller to deliver and a buyer to receive a deliverable debt obligation with payments linked to the performance of a set of debt obligations of a plurality of debt issuers, the delivery and payment being due on at least one of a plurality of days.

10. A computer implemented method according to claim 9 in which the computer implementation comprises a multi-threaded application written in an object-oriented programming language.

11. A computer implemented method according to claim 9 in which the computer implementation comprises an order book object and a connection object for maintaining the data flow between client and exchange and placing orders in the order book object.

12. A computer implemented method according to claim 9 in which auditing and logging are realised through a separate object maintaining connections to one or a plurality of external relational database management systems or flat files, and where price reporting to external data providers and pre-opening price discovery are handled through further objects.

13. A computer program product comprising a set of instructions for execution in a computer system which when executed cause the computer system to perform a method for trading a contract, the contract comprising a requirement for a seller to deliver and a buyer to receive a deliverable debt obligation with payments linked to performance of a set of debt obligations form a plurality of issuers, the payment being due on at least one of a plurality of days.
